(19) United States
(12) Patent Application Publication
(10) Pub. No.: US 2003/0000120 A1
(43) Pub. Date: Jan. 2, 2003

(54) Portable games board

(76) Inventor: Damian William McNamara, Narre Warren South Vic (AU)

Correspondence Address: John C. Kerins, MILES & STOCKBRIDGE P.C., Suite 500, 1751 Pinnacle Drive, McLean, VA, 22101-3833, US

(21) Appl. No.: 10/073,047

(22) Filed: Feb. 12, 2002

(30) Foreign Application Priority Data
Jun. 29, 2001 (AU) PR 6036

(51) Int. Cl. G09F 3/04

(52) U.S. Cl. 40/450

(57) ABSTRACT

A portable games board is provided which may be employed as a scoreboard. The games board includes a flexible sheet and a support structure for holding the sheet. The sheet has a series of digits in the form of the number “eight”, made of contrasting material and laid out in the format commonly used in LED displays, with seven linear strokes forming the “eight”. Each of the seven linear strokes of each digit has a flap which, when closed, covers the stroke, and, when open, the stroke is visible. The set of flaps may be used to form any number from 0 to 9.

The present invention relates to a portable games board that may be used as a scoreboard.

Typically, scoreboards consist of a large black metal plate having a series of peas protruding therefrom and a series of number plates on which digits are painted. The number plates are hung on the pegs to display the score of the game. In order to adjust the score, it is necessary to remove and replace each number plate separately. Depending on the size and weight of the number plates this task may be a difficult, particularly if the score changes quickly during a game. Furthermore, to display a score having the same digit in it more than once, it is necessary to have several number plates painted with the same digit.

These types of scoreboards are often fixed to a fence surrounding a sports ground or mounted to a fixed elevated structure. Therefore, these scoreboards are not easily moved between venues. In addition, children and younger players of a particular sport practicing the skills of a game cannot make use of this type of fixed scoreboard at home.

Accordingly, it is an object of the present invention to provide an alternative games board that can be used as a scoreboard.

According to the present invention there is provided a portable games board, the games board including:

a flexible sheet on which a series of digits representing numerical information relating to a game may be formed; and

a support structure for holding the sheet so that the digits formed on the sheet can be viewed,

wherein each digit includes a plurality of segments, and the value of each digit observed may be altered by selecting which segments forming the digits are visible, and each segment required to form a digit may be made visible by:

i) uncovering a section of the sheet having a visible mark on it that forms one of the required segments; and/or

ii) positioning a panel having a visible segment marked thereon on the sheet in a location of a required segment, and

wherein the flexible sheet is sufficiently flexible to enable the sheet to be folded or rolled for transportation or storage.

The “numerical information” may be a game score, or any other number such as a distance, ball speed, count on a batter (as in baseball) or time.

Accordingly, the present invention provides a portable games board in which the value of each digit and thus the numerical game information displayed on the sheet can be adjusted by selectively uncovering segments of digit marked on the sheet and/or positioning on the sheet panels which have segments of digits marked thereon. The portable games board can therefore be used by children and other players of a game to simulate a professional sporting event. In addition, the portable games board is easy to store and transport due to its flexibility and small number of components .

Preferably, the sheet has flaps that can be moved between a first position in which the segment is made visible, and a second position in which the segment is not visible, so that the necessary segments for forming a digit can be displayed. The segments may be marked directly on the sheet (and can be obscured by the flaps), or otherwise they can be marked on the flaps (which can be folded over to obscure the segment). Preferably the flaps are joined to the sheet so that a large number of separate pieces are not required to be kept together to have a complete games board. This is a significant advantage, especially for a games board for use by children who may loose parts of a set that comes in many pieces.

However, it is also possible for other types of elements to be used instead, such as plastic panels that can be held onto a plastic sheet by electrostatic forces.

Preferably, the segments of the digits are marked on the sheet, and a desired digit is able to be formed on the sheet by uncovering the required segments (for instance, by moving a covering panel from the second position in which it covers the segment to the first position in which it is uncovered).

Preferably, at least one of the digits that can be represented on the sheet is in the form of a figure eight, and flaps covering the sheet can be folded to allow segments of the figure eight to be viewed or obscured so that the figure eight can be altered to represent any single digit from 0 to 9.

Preferably, the digits that can be represented on the sheet are figure eights applied to the surface thereof, the figure eights having seven linear strokes commonly appearing in a digital liquid crystal display (LCD) or light emitting diode (LED). Accordingly, it is also referred that each figure eight has seven associated flaps, each flap being able to be used to cover one of the seven segments forming the figure eight.

In the situation where the sheet includes flaps, it is preferred that the sheet and flaps have co-operating hooks and loops attached to their respective faces for securing the flaps while covering or uncovering the segments of the digits. For example, the flaps can have a velcro-type hook-bearing strip on one face, and the sheet can have a velcro-type loop-bearing strip on a matching face for holding the flaps in one of the first and second positions.

According to an alternative embodiment, the flaps can be held in position by electrostatic forces.

According to a preferred embodiment of the invention, the sheet includes a representation of a target so that a player can practice their skills by aiming at the target. For example, a player may practice handballing, kicking, throwing or hitting a ball at the target on the sheet. The target may be represented by a marked target area, and/or a hole.

Preferably, the markings defining the target and the digits forming the scoreboard are on opposite sides of the sheet.

Preferably, the support structure consists of or includes a pair of poles. In use, the pair of poles can be positioned in a spaced apart upright orientation, and the sheet can be mounted to the poles. The support structure may also include one or more crossbars for supporting upper (and lower) edges of the sheet.

The poles may be or any suitable configuration. They may be multiple-part with ends shaped to enable the pieces to be slid together. The individual pieces for constructing one pole may be separate or may be linked together by an internal length of elastic in the manner of some tent poles. In another alternative, the poles may include two telescopically extendable parts that can be extended to elongate the pole and twisted relative to each other to lock the pole into the elongated position.

In normal use, the support structure of the present invention holds the sheet in position for use as either a target or scoreboard. According to a preferred embodiment of the present invention, the poles of the support structure may have the dual function of being able to represent goal posts when the sheet is removed. For example, the poles may be used an goal posts for Australian rules football, gridiron, soccer, field hockey or ice hockey. It is also envisaged that a not may be suspended between the poles for games such as volley ball and badminton

The sheet-type scoreboard may in fact constitute a part of the equipment used to play a sport or game. For example, the scoreboard may be a volleyball net having a game score panel on one or both sides thereof.

Preferably, the portable poles can be connected to an anchoring structure to hold the poles upright relative to the ground. The anchoring structure may be of any suitable configuration.

In an alternative, the support structure may be in the form of any other arrangement that can hold the sheet upright and flat during display. For example, the support structure may include two or more hooks that hook on to a top edge of the sheet and over the top edge of a fence, or into the links of a chain fence. In this embodiment, the sheet may have reinforced holes along its upper edge for receiving the hooks.

A preferred embodiment of the present invention will now be described in detail with reference to the accompanying figures, in which:

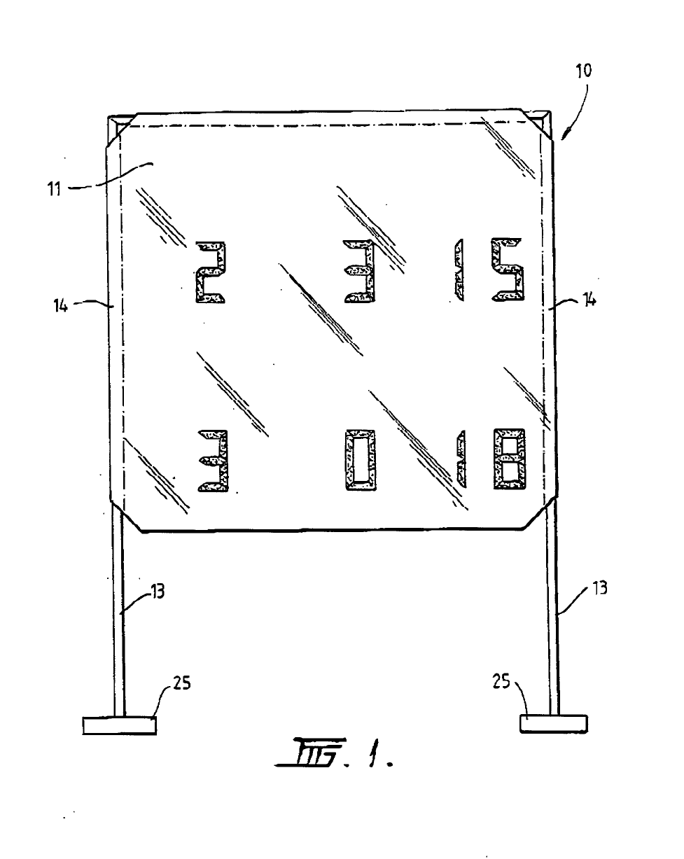

FIG. 1 in a front view of a games board of a first preferred embodiment.

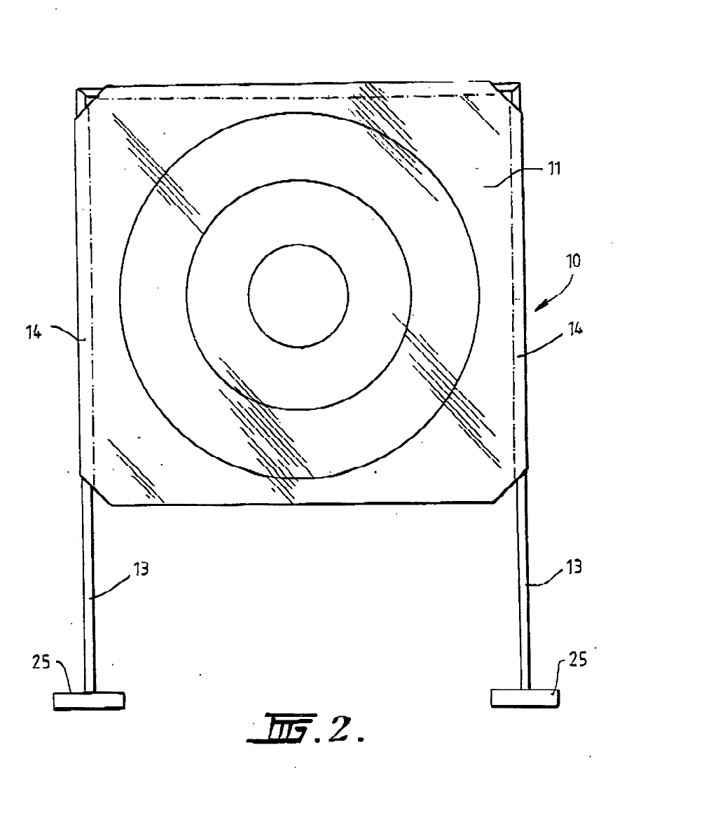

FIG. 2 is back view of the games board illustrated in FIG. 1.

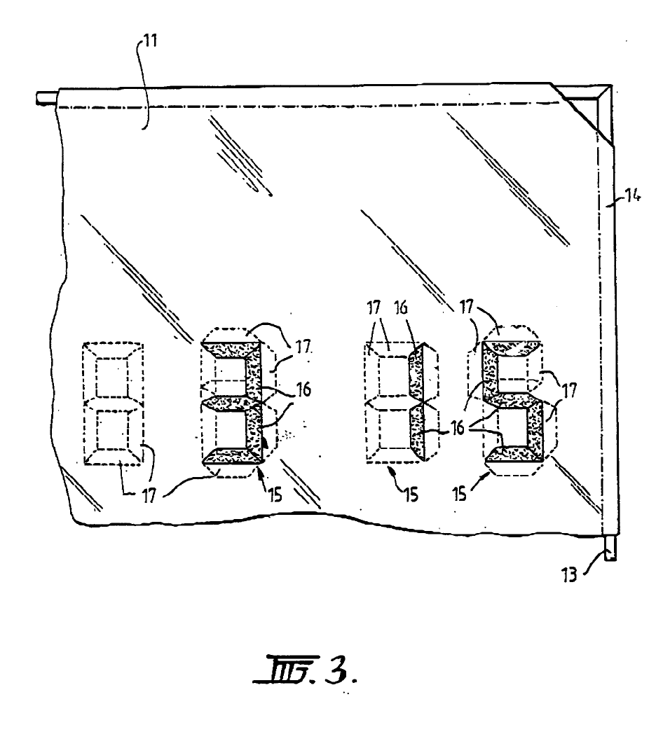

FIG. 3 is an enlarged view of the top right hand corner of the games board shown in FIG. 1.

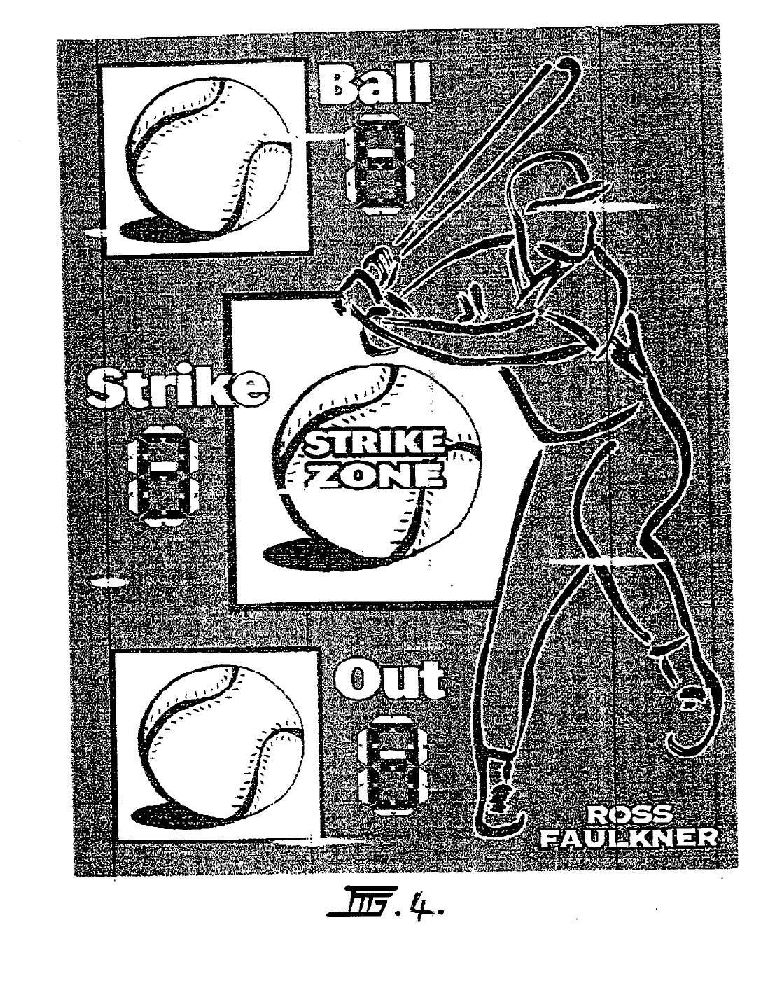

FIG. 4 is a front view of a games board of a second embodiment of the invention.

As can be seen in FIGS. 1 and 2, the preferred embodiment of the present invention includes a games board generally identified by reference numeral 10. The games board includes a sheet 11 of plastic on which a series of digits representing the score or a game may be formed and a support structure 12 in the form of two poles 13. The sheet 11 is sufficiently flexible or pliable to enable the sheet to be folded and/or rolled up for transportation and storage.

The sheet 11 has two sleeves 14 running along opposite edges through which the poles are threaded. An anchor structure in the form of weights 15 contacting a central cylindrical slot receives the-ends of the poles to hold the poles upright relative to the ground. As can be seen in FIGS. 1 and 2, the sheet is held taut between the poles 13 so that the digits formed on the sheet can be easily viewed.

FIG. 2 shows a target marked on the reverse face of the games board. A person can practice their skills by handballing, kicking and throwing a ball at the target. FIG. 4 illustrates an alternative target illustration suitable for baseball.

FIG. 3 illustrates in detail that each digit 15 formed on the sheet consists of seven segments 16 in the form of a FIG. 8. Each segment 16 is printed on the sheet and is covered by a plastic flap 17 that is permanently joined (for example, sewn and/or bonded) to the sheet 11. The segments 17 are represented in the figure in dark bold lines and the flaps 17, both folded and unfolded, are shown in broken lines. A single flap 17 overlies each segment 16 so that each flap 17 can be folded to reveal the segment 16 printed on the sheet beneath.

In the “unfolded position”, i.e. a “first position”, the flap covers the segment. In the “folded” position, i.e. a “second position”, the flap does not cover the segment.

In FIG. 3, the flaps 17 of the left-hand digit remain in the first position (closed) so that none of the segments 16 are visible. The three remaining digits illustrated in FIG. 3 show a mixture of some of the flaps 17 folded and unfolded so that the some of the segments 16 have been uncovered. As can be seen in FIG. 3, the flaps can be adjusted so the figure eight marked on the sheet can be altered to represent any digit from 0 to 9.

Although not illustrated in the drawings, the flaps may be held in either a folded or unfolded position by cooperating hook and loop fasteners (velcro strips) attached to the flaps and sheet. That is, the hook and loop fastener can fasten the flaps to either i) obstruct from view the segments printed in the sheet or ii) uncover the segments printed on the sheet to form a digit.

It will be understood by persons skilled in the art of the present invention that many modifications may be made without departing from the spirit and scope of the invention described above.

For example, the poles of the support structure may be telescopic.

For another example, the flaps may be held either flat against the sheet or folded back onto the sheet by electrostatic forces.

The claims defining the invention are as follows:

1. A portable games board comprising:
a flexible sheet on which a fixed number of digits representing numerical information relating to a game may be formed, wherein each of the digits is capable of being altered to be blank or to represent a number from 0 to 9, and wherein each of the numbers observed in formed by up to seven linear segments in a contrasting color to the background color of the sheet, such that when all seven segments are displayed, a figure “8” is displayed in simulated digital appearance; and
a support structure for holding the sheet in an upright orientation so that the digits formed on the sheet can be viewed,
wherein the sheet includes a plurality of flaps, one each being associated with each of the segments, each flap being joined to the sheet so that it can be moved by bending or folding between a first position in which the segment associated with the flap is made visible, and a second position in which the segment is obscured, so that the necessary segments for forming a desired digit can be displayed.

2. A portable games board according to claim 1, wherein the numerical information represented on the sheet is a game score, a distance, a speed, count on a batter, a time, or a combination of one or more of these forms of numerical information.

3. A portable games board according to claim 1, wherein each segment is marked in a contrasting color on the sheet, and when in the first position, a flap associated with a segment does not cover the segment, and when in the second position, the flap covers the segment.

4. A portable games board according to claim 1, wherein each segment is marked on the flap with which it is associated, and when in the first position tho flap is reveals the segment, and in the second position, the flap obscures the segment.

5. A portable games board according to claim 1, wherein the sheet and flaps include retaining means for securing the flaps in at least one of the first and second positions.

6. A portable games board according to claim 1, wherein the sheet and flaps include cooperating hooks and loops attached to their respective faces for securing the flaps in at least one of the first and second positions.

7. A portable games board according to claim 1, wherein the flaps can be held in the first and second positions by electro-static forces.

8. A portable games board according to claim 1, wherein the sheet includes a representation of a target.

9. A portable games board according to claim 8, wherein the markings defining the target and the digits forming the scoreboard are on opposite sides of the sheet.

10. A portable games board according to claim 1, wherein the support structure comprises a pair of poles onto which the sheet can be mounted.

11. A portable games board according to claim 10, wherein the support structure includes a crossbar for supporting an upper edge of the sheet.

12. A portable games board according to claim 1, wherein the scoreboard constitutes a part of the equipment used to play a sport or game.

13. A portable games board according to claim 10, wherein the supporting structure further includes an anchoring structure for receiving lower ends of the pair of poles to enable the poles to be held in an upright orientation.

14. A portable games board according to claim 1, wherein the flexible sheet is formed from plastic.
